(19) United States
(12) Patent Application Publication
(10) Pub. No.: US 2008/0116623 A1
(43) Pub. Date: May 22, 2008

(54) SPRING HOLDER APPARATUS

(76) Inventors: Geoffrey Frederick Crocker, Vancouver (CA); Steven Dennis Gabrys, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/562,886

(22) Filed: Nov. 22, 2006

(51) Int. Cl. F16F 1/06

(52) U.S. Cl. 267/169

(57) ABSTRACT

A spring holder apparatus to hold one or more springs is constructed of a first base having a first floor, a first flange extending from at least a portion of the first floor, a first wall and a first flexible locking element; and a second base having a second floor, a second flange extending from at least a portion of the second floor, a second wall and a second flexible locking element. The flanges are adapted to axially support the spring and the walls are adapted to radially support the spring. The walls are further adapted to interpose with one another so as to allow them to move past each other as the bases are urged toward each other during compression of the spring. The flexible locking elements are adapted to slidingly engage each other so as to secure the bases to each other while allowing the bases to move toward each other during compression of the spring.

### BACKGROUND OF THE INVENTION

1. Field of the Invention

The present disclosure relates to a spring holder suitable to hold one or more springs such as Belleville springs or coil springs.

2. Description of the Related Art

Belleville springs are conical shaped washers, designed to be loaded in the axial direction. Belleville springs can be statically loaded, either continuously or intermittently, or cyclically deflected, that is, dynamically loaded. Belleville springs are often used in internal combustion engines, turbine and jet systems, nuclear power plants, oil and gas exploration, fuel cells and may specifically be used to apply a pre-load or flexible quality to a joint including joints that experience thermal expansion and contraction. Load-deflection curves of Belleville springs may be regressive, progressive or straight. Stacks of Belleville springs have many other favorable attributes including a long service life, self damping properties, limited or no setting or fatigue under normal loads and stresses, as well as making an efficient use of space.

Specific spring characteristics can be attained by arranging multiple Belleville springs into stacked columns. For example, multiple Belleville springs may be stacked in an aligned coaxial orientation to increase the effective spring constant while maintaining the same overall maximum deflection capacity. Multiple Belleville springs may also be stacked in an alternating coaxial orientation to decrease the effective spring constant and increase the maximum deflection capacity. Multiple Belleville springs may be stacked in a combination of aligned coaxial orientation and alternating coaxial orientation to tune the desired spring constant and deflection capacity.

Another type of spring is a coil spring. Coil springs are made of an elastic material that may be helically shaped and, that may be compressed under an external force. Multiple coil springs may be stacked in an aligned coaxial orientation to attain desired spring constant characteristics and deflection capacity.

Among other things, stacks of one or more springs may be employed to store and subsequently release energy or to absorb shock or to maintain a force between contacting surfaces. In such use, it may be preferable for the orientation, alignment and position of a stack of springs to be maintained by an apparatus that holds the spring stack. Apparatus that hold spring stacks are known in the art and typically include uncompressible internal cylindrical shafts or external tubular cylinders. However, uncompressible internal cylindrical shafts or external tubular cylinder alignment apparatus known in the art are problematic. When an external force is applied to the stack of springs, the springs compress under that force. The uncompressible internal shaft or external tubular cylinder do not compress however, yielding an overall length difference between them. Thus, the spring holder apparatus must have an opening or cavity to accept the protruding uncompressible internal shaft or external tubular cylinder.

To address this problem, spring holder apparatus that collapse in harmony with the spring stack are known in the art. However, such apparatus are complex, expensive to manufacture, require many parts and require significant, complicated and time-consuming assembly.

There remains a need for a spring holder apparatus that compresses in harmony with the spring stack and that is simple to manufacture and assemble. The present disclosure addresses this need and provides associated benefits.

### BRIEF SUMMARY OF THE INVENTION

Briefly, at least one embodiment relates to an apparatus for holding a spring comprising a first base having a first floor, a first flange extending from at least a portion of the first base, a first wall and a first flexible locking element; and a second base having a second floor, a second flange extending from at least a portion of the second base, a second wall and a second flexible locking element. The flanges are adapted to axially support the spring and the walls are adapted to radially support the spring. The first wall is adapted to interpose with the second wall so as to allow the walls to move past each other as the bases are urged toward each other during compression of the spring. The flexible locking elements are adapted to slidingly engage each other so as to secure the bases to each other while allowing the bases to move toward each other during compression of the spring.

Briefly, at least one embodiment relates to spring holder apparatus that comprise a first base including a first floor having a perimeter, at least one first wall portion extending axially from the first floor proximate the perimeter of the first floor, a first flange extending laterally from the perimeter of the first floor outward of the at least one first wall portion, and a first flexible locking element; and a second base including a second floor having a perimeter, at least one second wall portion extending axially from the second floor proximate the perimeter of the second floor, a second flange extending laterally from the perimeter of the second floor outward of the at least one second wall portion, and a second flexible locking element, wherein the at least one second wall portion is slideably engaged by the at least one first wall portion and the first and the second flexible locking elements are configured to lockingly engage one another to movingly couple the first and the second bases together.

### BRIEF DESCRIPTION OF THE SEVERAL VIEWS OF THE DRAWING(S)

In the figures, identical reference numbers identify similar elements or acts. The sizes and relative positions of elements in the figures are not necessarily drawn to scale and some of these elements are arbitrarily enlarged and positioned to improve figure legibility. Further, the particular shapes of the elements as drawn are not intended to convey any information regarding the actual shape of the particular elements, and have been solely selected for ease of recognition in the figures.

FIG. 1 is a longitudinal-sectional view of a spring holder apparatus according to one illustrated embodiment.

FIG. 1A is a cross-sectional view of the spring holder apparatus according to FIG. 1 taken along line I-I in FIG. 1.

FIG. 2 is a longitudinal-sectional view of a spring holder apparatus according to another illustrated embodiment, showing a number of Belleville springs held in one possible arrangement.

FIG. 3 is a longitudinal-sectional view of a spring holder apparatus according to yet another illustrated embodiment, showing a number of Belleville springs held in another possible arrangement.

FIG. 4 is a longitudinal-sectional view of a spring holder apparatus according to still another illustrated embodiment, showing a number of coil springs held in one possible arrangement.

FIG. 5 is an exploded top plan view of a spring holder apparatus according to yet still another illustrated embodiment.

FIG. 6 is a longitudinal-sectional view of a spring holder apparatus according to another illustrated embodiment showing a number of Belleville springs held in one possible arrangement.

FIG. 7 is a perspective view of the spring holder apparatus of FIG. 6.

FIG. 8 is a perspective view of a spring holder apparatus according to yet still another illustrated embodiment.

### DETAILED DESCRIPTION OF THE INVENTION

In the following description, certain specific details are set forth in order to provide a thorough understanding of various embodiments. However, one skilled in the art will understand that various embodiments may be practiced without these details. In other instances, well-known structures have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

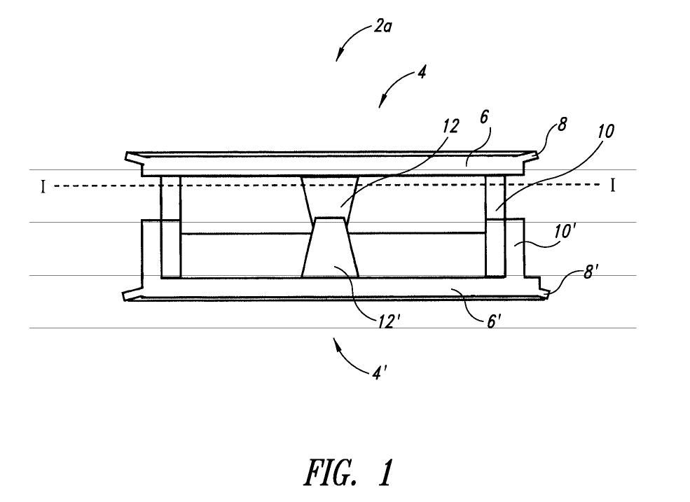

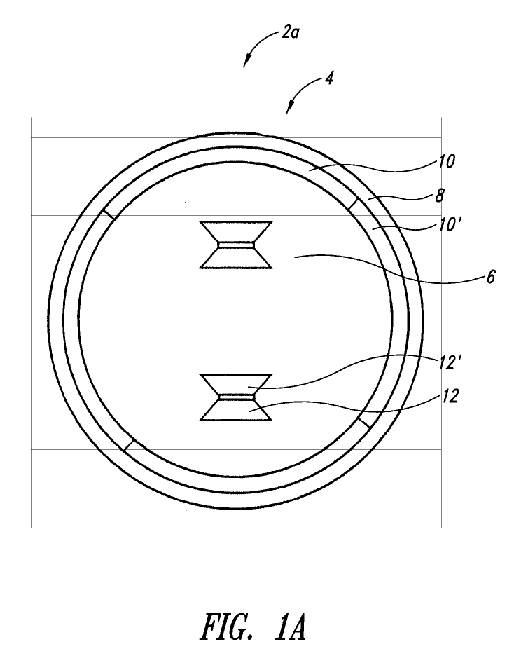

FIG. 1 is a longitudinal-sectional view of a spring holder apparatus 2a according to one illustrated embodiment. The spring holder apparatus 2a includes a first base 4 having a first floor 6, a first flange 8, a first wall 10 and a first flexible locking element 12. The spring holder apparatus 2a also includes a second base 4′ having a second floor 6′, a second flange 8′, a second wall 10′ and a second flexible locking element 12′. The first and second flanges 8, 8′ extend from at least a portion of the first and second floors 6, 6′, respectively, and are adapted and positioned to axially support a spring (not shown in FIG. 1). The walls 10, 10′ are adapted and positioned to radially support the spring and are further adapted to interpose with one another so as to allow the walls 10, 10′ to move past each other as the bases 4, 4′ are urged toward each other during compression of the spring. The interposition of the first and second walls 10, 10′ is better shown in FIG. 1A. The flexible locking elements 12, 12′ are adapted to slidingly engage each other so as to secure the bases 4, 4′ to each other.

Based on the teachings herein, a person of ordinary skill in the art may readily select the material and method of manufacture for a given application. Embodiments may be manufactured from any of a variety of materials, for example, plastics, metals and/or composites. When manufactured out of plastic, methods of injection molding well known in the art may be employed.

In operation, the bases 4, 4′ are positioned such that the flexible locking elements 12, 12′ are aligned with one another. A spring (not shown in FIGS. 1 and 1A) is captured between the bases 4, 4′ where the spring is axially supported by the flanges 8, 8′ and radially supported by the walls 10, 10′. The bases 4, 4′ are urged toward one another such that the walls 10, 10′ interpose with one another and the flexible locking elements 12, 12′ slidingly engage one another to secure the bases 4, 4′ to each other. An external element may continue to apply a force to compress the spring and urge the bases 4, 4′ further toward one another such that the walls 10, 10′ move past each other or further past each other and such that the flexible locking elements 12, 12′ allow the bases 4, 4′ to move toward each other.

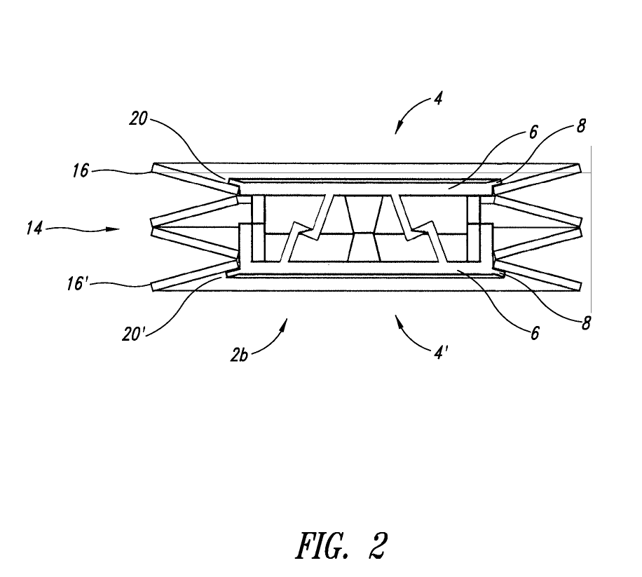

FIG. 2 is a longitudinal-sectional view of a spring holder apparatus 2b according to another illustrated embodiment. In particular, FIG. 2 shows a number of Belleville springs 14 held in a concave arrangement such that outermost springs 16, 16′ extend past the flanges 8, 8′. Herein an “outermost spring” means the first or last spring in a spring stack. In the embodiment depicted in FIG. 2, the flanges 8, 8′ axially support a shoulder 20, 20′ of the outside springs 16, 16′, respectively. A person of ordinary skill in the art will readily appreciate that the stack of Belleville springs 14 may, in some embodiments, consist of a single Belleville spring.

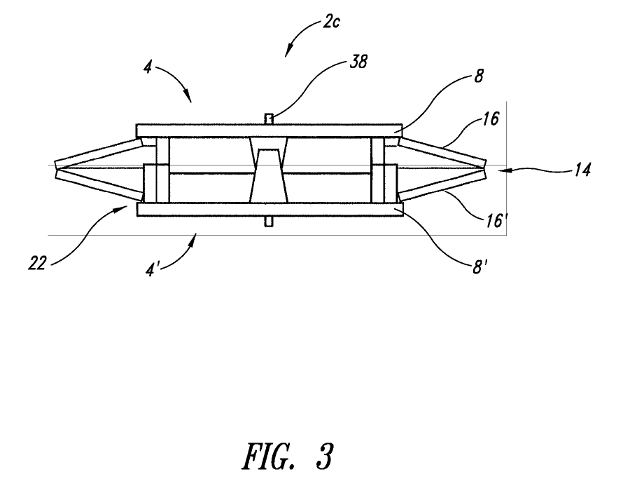

FIG. 3 is a longitudinal-sectional view of a spring holder apparatus 2c according to still another illustrated embodiment. In particular, FIG. 3 shows a number of Belleville springs 14 held in a convex arrangement such that the outermost springs 16, 16′ do not extend past the flanges 8, 8′. The flanges 8, 8′ axially support the outer surface of an inner diameter 22 of the outermost springs 16, 16′.

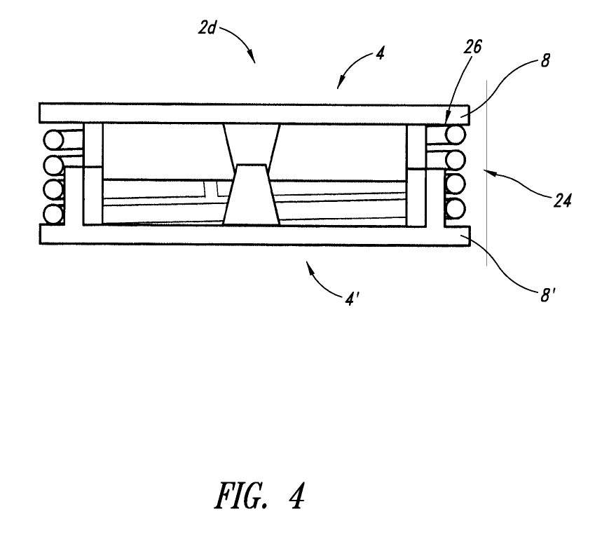

FIG. 4 is a longitudinal-sectional view of a spring holder apparatus 2d according to yet another illustrated embodiment. In particular, FIG. 4 shows a number of coil springs 24 held in one possible arrangement where the flanges 8, 8′ axially support an outside end 26 of the stack of coil springs 24. A person of ordinary skill in the art will readily appreciate that the stack of coil springs may be composed of a single coil spring.

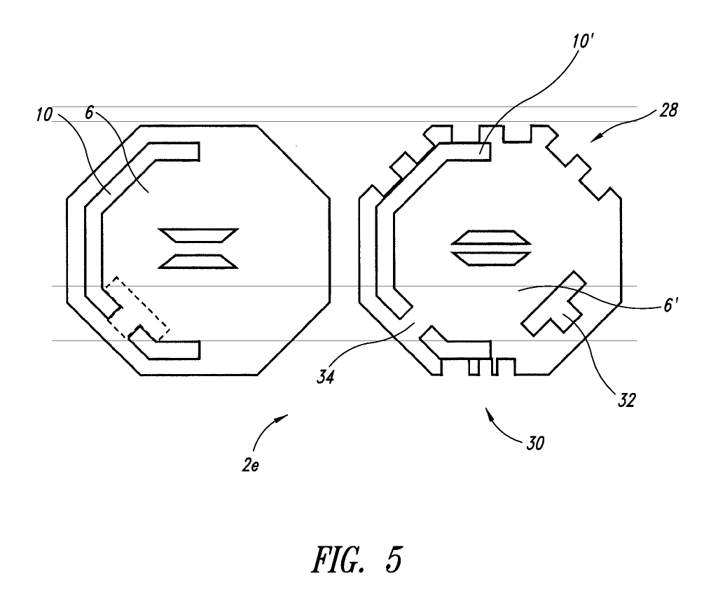

FIG. 5 is an exploded top plan view of a spring holder apparatus 2e according to yet still another illustrated embodiment. The spring holder apparatus 2e has octagonal floors 6, 6′. The shape of the floors 6, 6′ is not essential to the various embodiments and may be chosen by a person of ordinary skill in the art to accommodate the shape or profile of the spring. For example, the shape of the floors 6, 6′ may be circular, rectilinear, pentagonal, hexagonal or amorphous in shape. For example, FIG. 1A shows a circular first floor 6. The floors 6, 6′ may be of any material, dimension and thickness that is suitable for a particular application as desired. For example, thicker materials may possess the advantage of greater structural integrity whereas thinner materials may be more lightweight.

The size, shape and arrangement of the flanges 8, 8′ is not essential to the various embodiments and may be readily selected by a person of ordinary skill in the art depending on the particular application, provided that the flanges 8, 8′ are adapted to axially support the spring. For example, FIG. 2 shows flanges 8, 8′ thinner than and angled with respect to the floors 6, 6′ in order to align with the shoulder of Belleville spring 14. One advantage of thinner flanges 8, 8′ is that they may more readily flatten in accord with a Belleville spring under compression, if desired. Also for example, FIG. 3 shows the flanges 8, 8′ substantially coplanar and of equal thickness with the floors 6, 6′ providing greater structural integrity where flexibility of the flanges 8, 8′ is not desired. Flexible flanges 8, 8′ may not be desired where a convex arrangement of Belleville springs is used or where a stack of coil springs 24 is held, for example.

The flanges 8, 8′ may be made of any dimension required for a particular application. For example, a spring with a high spring constant may require the flanges 8, 8′ to have greater supporting qualities as compared to that required for a spring with a lower spring constant.

FIG. 1A shows the flange 8 as contiguous and completely circumscribing the first floor 6. In contrast, FIG. 5 shows the flanges 8, 8′ as regularly interrupted 28 and irregularly interrupted 30, for at least the purpose of increasing their flexibility in order to flatten or for other reasons apparent to a person or ordinary skill in the art including lighter weight, reduced material costs and increased ease of manufacture.

The shape of the walls 10, 10′ is not essential to the various embodiments and the walls 10, 10′ may have any shape provided the walls 10, 10′ are adapted to radially support the spring and provided the walls 10, 10′ are adapted to interpose with one another so as to allow the walls 10, 10′ to move past each other as the bases 4, 4′ are urged toward each other during compression of the spring. The walls 10, 10′ may further be adapted to preclude relative rotation of the bases 4, 4′. Such preclusion of rotation prevents the flexible locking elements 12, 12′ from disengaging from one another under rotation.

FIG. 1A shows arc-shaped walls 10, 10′ to radially support a circular shaped spring (not shown in FIG. 1A) where the walls 10, 10′ are symmetrically interposed. FIG. 5 shows octagonal-arc-shaped walls 10, 10′ to radially support an octagonal, circular or other shaped spring (not shown in FIG. 5) where the walls 10, 10′ are asymmetrically interposed. The sum of the angles subtended by the walls 10, 10′ need not equal 360 degrees, but may be greater than or less than 360 degrees. FIG. 5 shows a portion of wall 10′, indicated by numeral 32 that is made radially stepwise. Dashed lines in FIG. 5 represent the radial stepwise wall 32 in position on the opposing base when in an assembled state. Advantages of a stepwise wall 32 include greater structural integrity and further preclusion of relative rotation of the bases 4, 4′. FIG. 5 also shows a gap in the walls 10,10′ indicated by numeral 34. Advantages of the gap 34 include lighter weight, less material for manufacture and ease of manufacture.

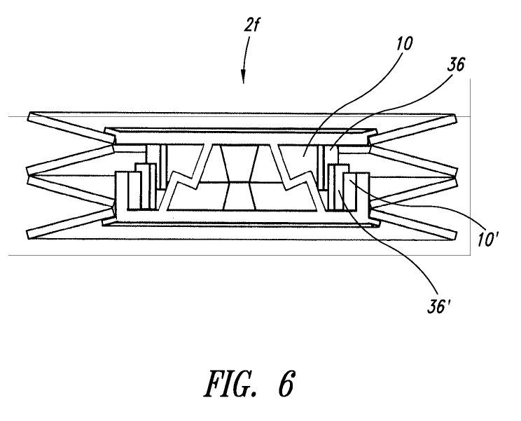

The height of the walls 10, 10′ may be selected to ensure that they are adapted to provide sufficient radial support of the spring and sufficient compression of the spring as desired for the particular application. A stack of springs comprised of a large number of springs may require walls 10, 10′ to be of greater height than that required by a stack of spring comprised of fewer springs. Furthermore, the walls 10, 10′ need not be of uniform height but may be made axially stepwise of varying heights for at least the purpose allowing the walls 10, 10′ to interpose with one another as the bases are urged toward each other before the flexible locking elements 12, 12′ slidingly engage one another. FIG. 6 shows the walls 10, 10 made stepwise as indicated by numeral 36 for the wall 10 and numeral 36′ for the wall 10′. One advantage of axially stepwise walls 10,10′ is improved ease of operation where the walls 10, 10′ interpose with one another in such a manner to ensure the flexible locking elements 12, 12′ are aligned with one another for sliding engagement as the bases 4, 4′ are urged toward one another.

The flexible locking elements 12,12′ may take any of a variety of forms provided that the flexible locking elements 12, 12′ slidingly engage one another to secure the bases 4, 4′ to one another while allowing the bases 4, 4′ to move towards each other during compression of the spring. For example, in various embodiments, the flexible locking elements 12, 12′ may comprise one or more flexible snap lock arms or ball and socket snaps.

In another embodiment, at least one of the bases 4, 4′ further includes a registration element. For example, FIG. 3 shows a registration element 38 to align the apparatus with external elements (not shown). The shape and position of the registration element 38 is not essential to the various embodiments. The registration element 38 may, for example, take the form of a peg, post, tab, slot or cavity or other known or later developed registration elements, as desired, depending on the nature of the application and the external element. The size, shape and position of the registration element 38 may also take a variety of forms as desired.

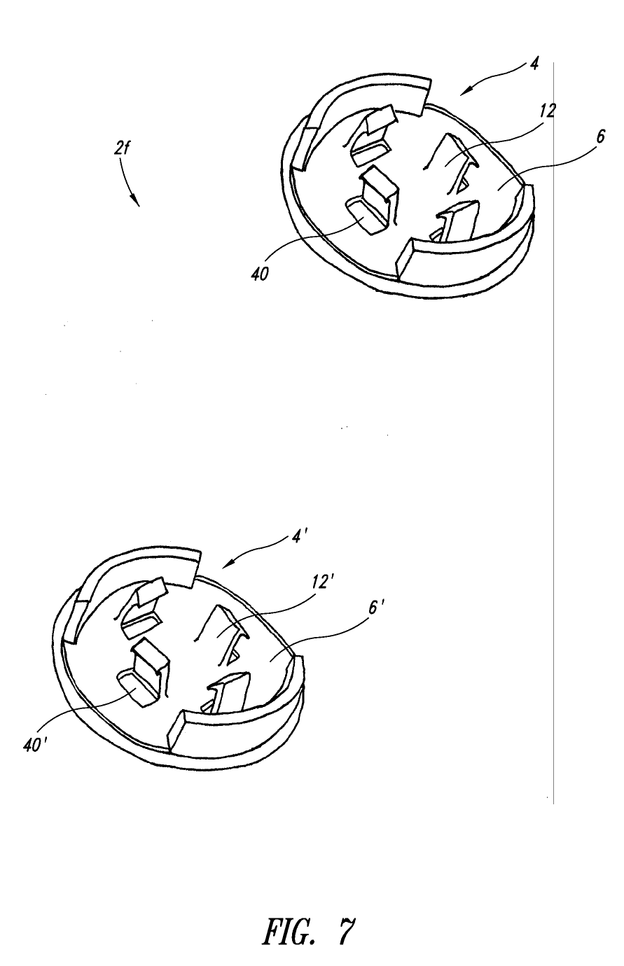

FIG. 7 shows another embodiment of the spring holder apparatus 2f, where at least one of the floors 6, 6′ may form a cavity. In particular, FIG. 7 shows a first cavity 40 in the first floor 6 which comprises a passage through the first floor 6. The first cavity 40 may allow the second flexible locking element 12′ to extend into the first floor 6 under compression of the spring. Likewise, a second cavity 40′ in the second floor 6′ may allow the first flexible locking element 12 to extend into the second floor 6′ under compression of the spring. The first and second cavities 40, 40′ may allow for insertion of a tool for disengagement of the flexible locking elements 12, 12′ from one another.

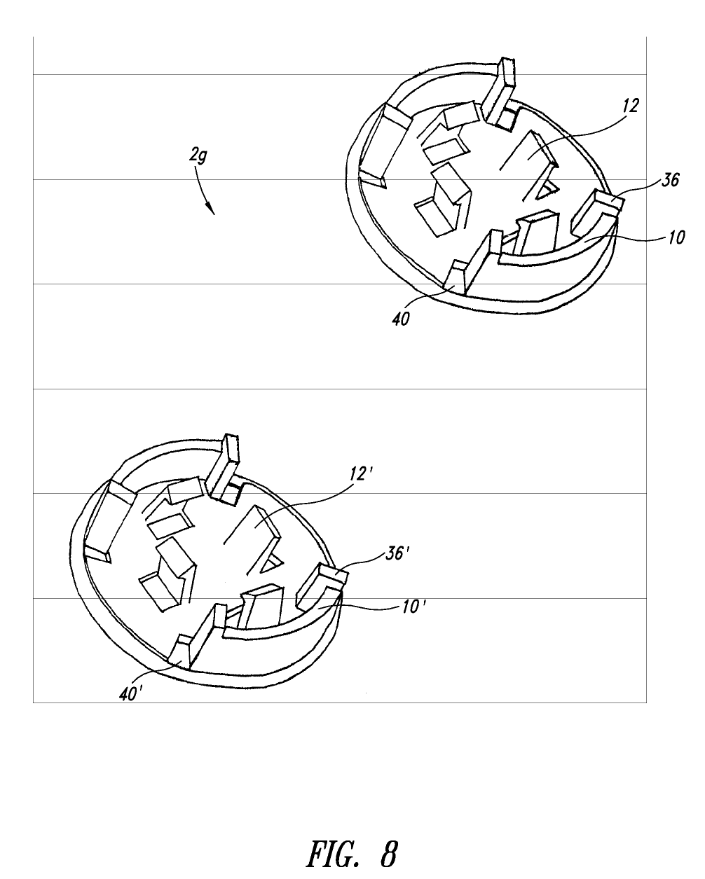

FIG. 8 is a perspective view of a spring holder apparatus 2g according to another illustrated embodiment. In particular, FIG. 8 shows that the first cavity 40 may also allow the second wall 10′, made axially stepwise as indicated by numeral 36′, to extend into the first floor 6 under compression of the spring. Likewise, the second cavity 40′ may allow the first wall 10, made axially stepwise as indicated at numeral 36, to extend into the second floor 6′.

The cavities 40, 40′ may also aid in manufacture. For example, in manufacture by injection molding, the cavities 40, 40′ may be used to ensure that the bases 4, 4′ are not trapped in their molds and to ensure that the molds can be completely filled before the molten plastic or like material solidifies or sets, commonly referred to in the art as telescoping shut-offs.

Cavities 40, 40′ may comprise a depression or may comprise a passage at least for the purpose of allowing at least one of the flexible locking elements 12, 12′ to extend into at least one of the floors 6, 6′ and for allowing at least one of the axially stepwise walls 10, 10′ to extend into at least one of the floors 6, 6′ under compression of the spring. For example, a passage is depicted in FIGS. 7 and 8.

The size, shape and position of the cavities 40, 40′ may be selected depending on the nature of the flexible locking elements 12, 12′, the nature of the walls 10, 10′, the extent of compression required, the nature of any tool used to disengage the flexible locking elements 12, 12′ from one another (if a tool is employed) and the nature and type of manufacture.

In one embodiment, the two bases 4, 4′ may be identical to one another. FIGS. 1, 1A, 2, 3, 4, 6, 7 and 8 show embodiments where the both bases 4, 4′ of any given embodiment are identical to each other. The advantages of such an embodiment include reduction of tooling, costs and the number of parts and an increase in the ease and simplicity of manufacturing, assembly and operation.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other spring holder assemblies, not necessarily the exemplary spring holder assemblies generally described above.

The various embodiments described above can be combined to provide further embodiments. Aspects of the embodiments can be modified, if necessary, to employ structures and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A spring holder apparatus, comprising:
a first base having a first floor, a first flange extending from at least a portion of the first floor, a first wall and a first flexible locking element;
a second base having a second floor, a second flange extending from at least a portion of the second floor, a second wall and a second flexible locking element;
wherein the first and the second flanges are adapted to axially support a spring;
wherein the first and the second walls are adapted to radially support the spring and interpose with one another so as to allow the walls to move past each other as the bases are urged toward each other during compression of the spring; and
wherein the first and the second flexible locking elements are adapted to slidingly engage each other so as to secure the first and the second bases to each other while allowing the first and the second bases to move toward each other during compression of the spring.

2. The spring holder apparatus of claim 1 wherein the first and the second bases are identical.

3. The spring holder apparatus of claim 1 wherein at least one of the first and the second floors is substantially planar.

4. The spring holder apparatus of claim 1 wherein the first wall is substantially perpendicular to the first floor.

5. The spring holder apparatus of claim 1 wherein at least one of the first and the second flexible locking elements comprises a flexible snap lock arm.

6. The spring holder apparatus of claim 1 wherein at least one of the first and the second flexible locking elements is positioned within an area delineated by a uperposition of the first wall and the second wall.

7. The spring holder apparatus of claim 1 wherein the first wall is further adapted to interpose with the second wall so as to preclude rotation of the first base with respect to the second base.

8. The spring holder apparatus of claim 1 wherein at least one of the first and the second walls is a radially stepwise wall.

9. The spring holder apparatus of claim 1 wherein at least one of the first and the second walls is an axially stepwise wall.

10. The spring holder apparatus of claim 1 wherein at least one of the first and the second floors form a cavity.

11. The spring holder apparatus of claim 1 wherein at least one of the first and the second base further comprise a registration element.

12. The spring holder apparatus of claim 1 wherein at least one of the first and the second floors have a substantially circular perimeter.

13. The spring holder apparatus of claim 1 wherein at least one of the first and the second flanges are contiguous.

14. The spring holder apparatus of claim 1 wherein at least one of the first and the second walls are arc-shaped.

15. A spring holder apparatus, comprising:
a first base including a first floor having a perimeter, at least one first wall portion extending axially from the first floor proximate the perimeter of the first floor, a first flange extending laterally from the perimeter of the first floor outward of the at least one first wall portion, and a first flexible locking element; and
a second base including a second floor having a perimeter, at least one second wall portion extending axially from the second floor proximate the perimeter of the second floor, a second flange extending laterally from the perimeter of the second floor outward of the at least one second wall portion, and a second flexible locking element, wherein the at least one second wall portion is slideably engaged by the at least one first wall portion and the first and the second flexible locking elements are configured to lockingly engage one another to movingly couple the first and the second bases together.

16. The spring holder apparatus of claim 15 wherein the first base member includes at least two first wall portions and the second base member includes at least two second wall portions, the second wall portions interposed between respect pairs of the first wall portions.

17. The spring holder apparatus of claim 16 wherein the first and the second wall portions have an outer perimeter dimensioned to receive the spring thereabout.

18. The spring holder apparatus of claim 17 wherein each of the first and the second flanges extend laterally from the first and second wall portions, respectively, by a distance sufficient to support the spring thereon.

19. The spring holder apparatus of claim 18 wherein the first and the second flexible locking elements are spaced inwardly of the outer perimeter of the first and the second wall portions.

20. The spring holder apparatus of claim 15 wherein the at least one of the first wall portions extends axially from the first floor at a right angle.
